(19) United States
(12) Patent Application Publication
(10) Pub. No.: US 2024/0074834 A1
(43) Pub. Date: Mar. 7, 2024

(54) MODIFIABLE ORTHODONTIC FACEBOW

(71) Applicants: BASEL RACHID AL MIDANI, Damascus (SY); ELIE JACK MUNAIRJI, Damascus (SY)

(72) Inventors: BASEL RACHID AL MIDANI, Damascus (SY); ELIE JACK MUNAIRJI, Damascus (SY)

(21) Appl. No.: 18/078,932

(22) Filed: Dec. 10, 2022

Related U.S. Application Data
(60) Provisional application No. 63/404,223, filed on Sep. 7, 2022.

(51) Int. Cl. A61C 7/06

(52) U.S. Cl. CPC A61C 7/06

(57) ABSTRACT

A modifiable orthodontic facebow is disclosed which is used with the head-strap and/or neck-pad for treating orthodontic cases. The modifiable orthodontic facebow of the present invention comprises an inner bow adapted to be inserted into a buccal tube of a molar band and an outer bow connected to the inner bow by means of an anterior hinge, wherein the anterior region of the outer bow is connected to the posterior region of the outer bow through a pair of side hinges comprising a first section and a second section, wherein the posterior region of the outer bow comprises a plurality of interconnected units, wherein a first interconnected unit is fixed to the second section of the side hinge followed by a plurality of intermediary interconnected units with a terminating unit comprising a j-hook to secure an elastic band.

### FIELD OF INVENTION

The present invention relates generally to medical devices. More particularly, the present invention is related to a modifiable orthodontic face-bow.

### BACKGROUND OF THE INVENTION

Typically, an orthodontic headgear may consist of head-strap and a facebow with inner and outer arch welded together in a short anterior area to become as one part. Clinicians may often refer to headgear as cervical-, straight-, or high-pull, indicating the buccal-view angulation of the outer-bow and line-of-action of the active force.

The (standard welded) outer and inner bow are parallel, and on the same level vertically (when placed on a flat surface), and needs to be altered vertically if indicated. A bend is to be placed to raise or lower the outer bow. The inner-bow (face-bow) circular cross-section diameter may approximately be 1.2 mm and may be available in five different lengths: 83 mm, 90 mm, 97 mm, 104 mm, 111 mm.

The inner bow (face-bow) inserts through buccal tubes of first or second molar bands. The elastic force (rubber band) may be hung between the j-hook (terminal part of the outer bow) and the head-gear strap. The active force may be delivered bilaterally to the outer-bow arm ends, transmitted anteriorly through the outer-bow arms, then through the bows connection (welded area) into the inner bow, posteriorly through the inner-bow arms, and through stops into the buccal tubes. The active force is generated by the elongation of an elastic traction band, one or more pairs of elastics, or a pair of springs, attached to the outer-bow arm ends.

The accompanying responsive force(s) are transmitted to the neck pad and/or head strap which, in turn, distributes that force over the back of the neck. The headgear has many uses, symmetric and asymmetric according to face-bow shape, and its outer-bow length. Headgear is used to restrain maxillary growth, distalize maxillary molars with or without the maxillary dental arch as a whole, or hold the molars in place (anchorage reinforcement) while retracting the canines and anterior segment into a posterior extraction space. Commonly, these objectives are required in a symmetric fashion. However, occasionally, the requirement on one side of the dental arch does not equal that of the left side, and an asymmetric extra-oral force system may be recommended.

The asymmetric headgear face bow is used when we need differential molar retraction force on one side of the dental arch than the other to correct the malocclusion on the side while the other side is normal. For example, when we need to correct unilateral class II malocclusion where it's class II molar is on one side and class I on the other side, would require an asymmetric force system generating distalization of the Class II molar while holding the Class I molar in place. The asymmetric face-bow is an effective, widely used appliance for asymmetric molar distalizations because it provides asymmetric distal force distribution to the right and left molars.

Conventional facebows have one or more disadvantages. Some of the disadvantages of the traditional face-bows include: (i) each patient needs to purchase a standard face-bow with a different size accustomed to his personal jaw size and can't be used on a different patient; (ii) the length of the outer bow is difficult to modify; (iii) the angle of the outer-bow in relation to the inner bow can't be changed unless doing a (permanent) deforming bend which could lead to its fracture.

The present disclosure proposes a solution to overcome the above-mentioned disadvantages.

### SUMMARY OF THE INVENTION

In light of the disadvantages mentioned in the previous section, the following summary is provided to facilitate an understanding of some of the innovative features unique to the present invention and is not intended to be a full description. A full appreciation of the various aspects of the invention can be gained by taking the entire specification and drawings as a whole.

Embodiments of the present disclosure propose a modifiable orthodontic facebow which is used with the head-strap and/or neck-pad in treating orthodontic cases. A modifiable orthodontic facebow comprises an inner bow adapted to be inserted into a buccal tube of a molar band and an outer bow connected to the inner bow by means of an anterior hinge, wherein the anterior region of the outer bow is connected to the posterior region of the outer bow through a pair of side hinges comprising a first section and a second section, wherein the posterior region of the outer bow comprises a plurality of interconnected units, wherein a first unit is fixed to the second section of the side hinge followed by a plurality of intermediary interconnected units with a terminating unit comprising a j-hook to secure an elastic band.

The anterior hinge of the outer bow facilitates insertion and removal of the inner bow of varying sizes, wherein the anterior hinge comprises a posterior drill hole to facilitate non-removable insertion of the mid-section of the outer bow by welding it in place.

The anterior hinge comprises an inner bow holder section with a removable upper part comprising a semi-circular recess and a fixed lower part comprising a mating semi-circular recess, wherein both the semi-circular recess and the mating semi-circular recess facilitates attachment of the inner bow to the anterior hinge.

The removable upper part and the fixed lower part of the inner bow holder section are joined together by a fastening mechanism, wherein the fastening mechanism is facilitated by a retention drill hole with a threaded insert for a fastener.

The pair of side hinges comprising the first section and second section are detachable, wherein the first section of the side hinge is welded to the anterior region of the outer bow and the second section is welded to the first unit of the plurality of interconnected units of the outer bow.

The first section and the second section of the pair of side hinges comprises a hole with a threaded insert for facilitating fastening of the first section and the second section of the side hinge with a fastener.

The first section and the section of the pair of side hinges comprises a smooth outer surface and a grooved inner surface, wherein upon fastening the first section and the second section of the pair of side hinges, the grooved surface of the first section and the second section fit into each other to prevent movement.

The plurality of intermediary interconnected units is cylindrical in shape with a screw positioned centrally to its anterior region and a hole comprising a threaded insert to facilitate insertion of the screw.

The terminating unit comprises a screw positioned to its centre to facilitate fastening to the first interconnected unit 118a or to at least one of the plurality of the intermediary interconnected units. Further the pair of side hinges exhibit a capability to rotate 360 degrees 1 planes of space.

This summary is provided merely for the purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following detailed description and figures.

The above-mentioned embodiments and further variations of the proposed invention are discussed in further in the detailed description.

### BRIEF DESCRIPTION OF THE DRAWINGS

FIG. 1 is an exemplary illustration of a top view of the modifiable orthodontic facebow according to the embodiments of the present disclosure.

FIG. 2 is an exemplary illustration of a perspective view of the modifiable orthodontic facebow according to the embodiments of the present disclosure.

FIG. 3 is an exemplary illustration of a top view of an anterior hinge according to the embodiments of the present disclosure.

FIG. 4 is an exemplary illustration of the insertion and removal of the outer bow from the anterior (middle) hinge and the working mechanism of the middle hinge according to the embodiments of the present disclosure.

FIG. 5 is an exemplary illustration of various components of the anterior hinge according to the embodiments of the present disclosure.

FIG. 6 includes exemplary illustrations of the pair of side hinges of the outer bow in different views according to the embodiments of the present disclosure.

FIG. 7 illustrates the working mechanism of the pair of side hinges in dynamic and static states according to the embodiments of the present disclosure.

FIG. 8 includes illustrations of the pair of side hinges according to the embodiments of the present disclosure.

FIG. 9 illustrates different views of the outer bow arm and its components according to the embodiments of the present disclosure.

FIG. 10 illustrates the ability to increase and decrease the length of the outer bow arm according to the embodiments of the present disclosure.

### DETAILED DESCRIPTION OF THE INVENTION

In the following description of the embodiments of the invention, reference is made to the accompanying drawings that form a part hereof, and in which are shown by way of illustration-specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limited sense, and the scope of the present invention is defined only by the appended claims.

The specification may refer to “an”, “one” or “some” embodiment(s) in several locations. This does not necessarily imply that each such reference is to the same embodiment(s), or that the feature only applies to a single embodiment. Single feature of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements and/or components, but do not preclude the presence or addition of one or more other features integers, steps, operations, elements, components, and/or groups thereof. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Embodiments of the present disclosure propose a modifiable orthodontic face-bow 100 which is used with the head-strap and/or neck-pad in treating orthodontic cases. A modifiable orthodontic facebow 100 comprises an inner bow 102 adapted to be inserted into a buccal tube of a molar band and an outer bow 104 connected to the inner bow 102 by means of an anterior hinge 106, wherein the anterior region 108 of the outer bow 104 is connected to the posterior region 110 of the outer bow 104 through a pair of side hinges 112 comprising a first section 114 and a second section 116, wherein the posterior region 110 of the outer bow 104 comprises a plurality of interconnected units 118, wherein a first interconnected unit 118a is fixed to the second section 116 of the side hinge 112 followed by a plurality of intermediary interconnected units 118b, 118c, 118d, 118e, 118f with a terminating unit 118g comprising a j-hook to secure an elastic band.

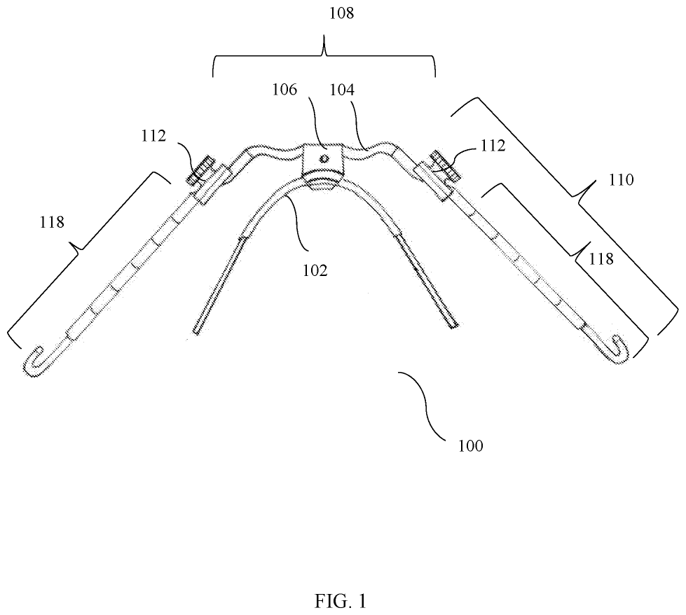

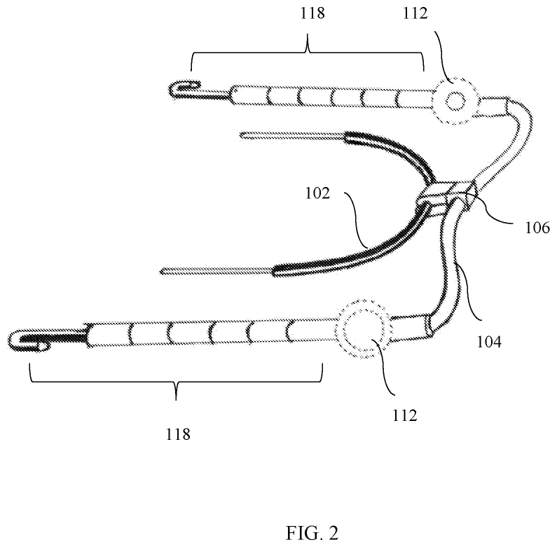

Referring to the figures, FIG. 1 is an exemplary illustration of a top view of the modifiable orthodontic face-bow 100 according to the embodiments of the present disclosure. FIG. 2 is an exemplary illustration of a perspective view of the modifiable orthodontic face-bow 100 according to the embodiments of the present disclosure. FIG. 1 depicts the outer bow 104, the inner bow 102, the pair of side hinges 112 and the anterior hinge 106. The modifiable orthodontic facebow 100 consists of inner bow 102 and outer bow 104. The inner bow 102 and outer bow 104 may be connected by inserting the inner bow 102 into the anterior hinge 106 welded to the outer bow 104. The two parts of the outer bow 104 (anterior and lateral) connect through the side hinge 106. The anterior hinge 106 of the outer bow 104 facilitates the insertion and removal of the inner bow 102 of varying sizes.

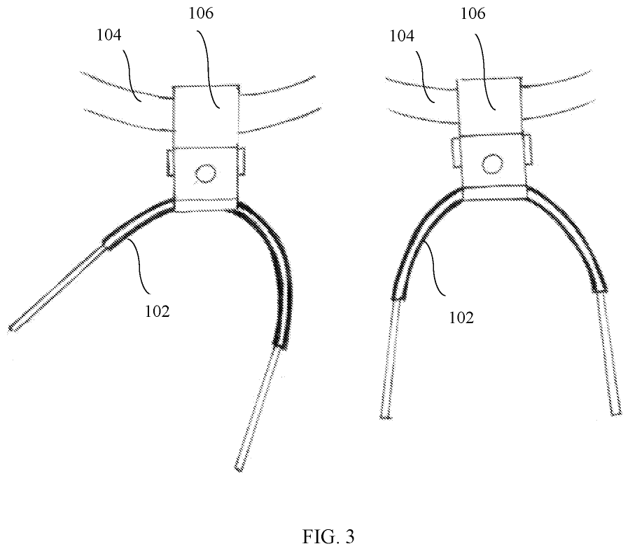

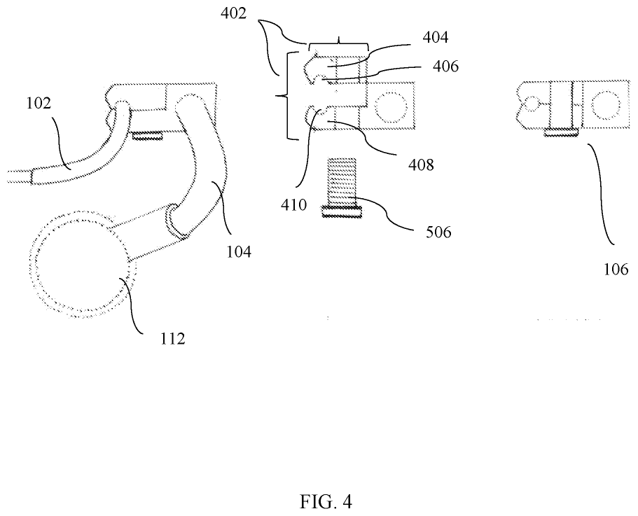

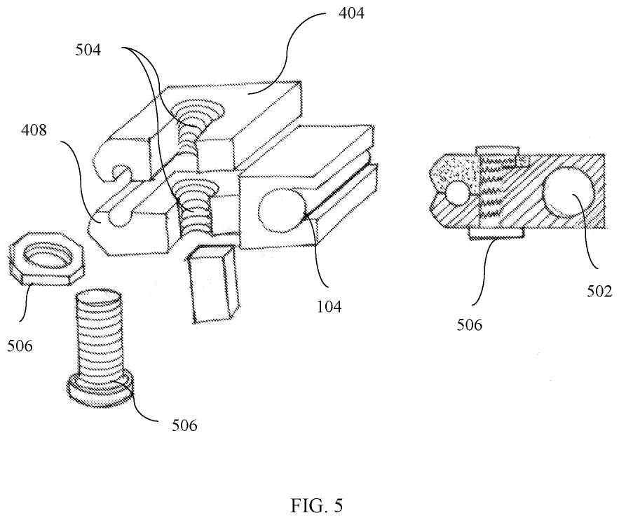

FIG. 3 is an exemplary illustration of a top view of an anterior hinge 106 according to the embodiments of the present disclosure. FIG. 4 is an exemplary illustration of the insertion and removal of the inner bow 102 from the anterior (middle) hinge 106 and the working mechanism of the middle hinge according to the embodiments of the present disclosure. FIG. 5 is an exemplary illustration of various components of the anterior hinge 106 according to the embodiments of the present disclosure. The anterior hinge 106 comprises a posterior drill hole 502 to facilitate the non-removable insertion of the mid-section of the outer bow 104 by welding it in place.

The anterior hinge 106 comprises an inner bow holder section 402 with a removable upper part 404 comprising a semi-circular recess 406 and a fixed lower part 408 comprising a mating semi-circular recess 410, wherein both the semi-circular recess 406 and the mating semi-circular recess 410 facilitates attachment of the inner bow 102 to the anterior hinge 106. The removable upper part 404 and the fixed lower part 408 of the inner bow holder section 402 are joined together by a fastening mechanism, wherein the fastening mechanism is facilitated by a retention drill hole 504 with a threaded insert for a fastener 506.

In a non-limiting example, the components along with the dimensions of the anterior hinge 106 include a posterior drill hole 502 with a diameter of 4 mm for an anterior part of the outer bow 104 to be inserted within it so that both can be welded together. The posterior part that surrounds the anterior (middle) outer bow 104 part is 4 mm in height, 6 mm in length and 4 mm in width. The later (two) part extends from the posterior part to stabilize the upper part 404, wherein it is 2 mm in width and 5 mm in height. Further, the retention drill hole 504 in the lower part 408 of the anterior hinge 106 has a 3 mm diameter and 3 mm height and the penetrated upper part 404 is 3 mm in diameter and 3 mm in height. The retentive screw 506 inserts from below or above the piece and through the piece and its diameter is 3 mm and length is 3 mm. The lower part 408 of the anterior hinge 106 is welded and stable with the lateral part and the posterior part. The 1 mm diameter concave part 406, 410, for inner bow 102 seating, is 0.5 mm in diameter in one piece and 0.5 mm in diameter in the other piece. The upper part/piece (404) of the anterior hinge 106 is removable upon unscrewing the screw 506 so that it allows for insertion of the inner bow 102. A nut 508 is provided to hold the screw 506 on the upper surface of the anterior hinge 106.

Further the anterior part 108 of the outer bow 104 is 70 mm in length measured linearly between the two side hinges 112. The anterior (middle) hinge 106 is located midway between the pair of side hinges 112 dividing it into two equal parts. It may be appreciated that the middle part of the outer bow 104 has bends to adapt away from soft tissues of the face to prevent irritation, and the anterior hinge 106 is welded into it as is the side hinges 112 welded on the outer bow 104 ends.

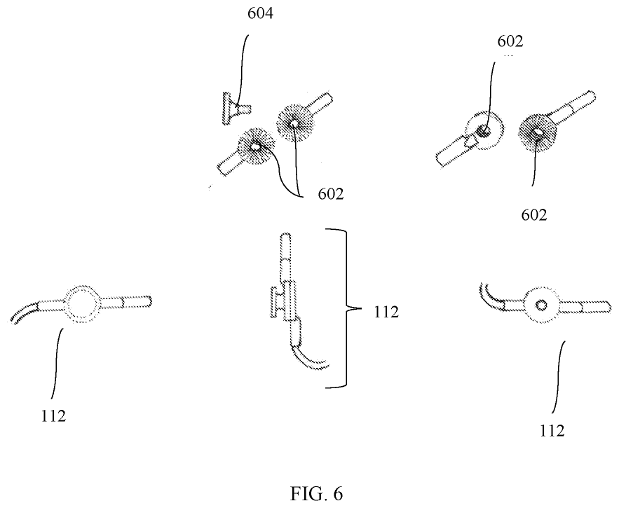

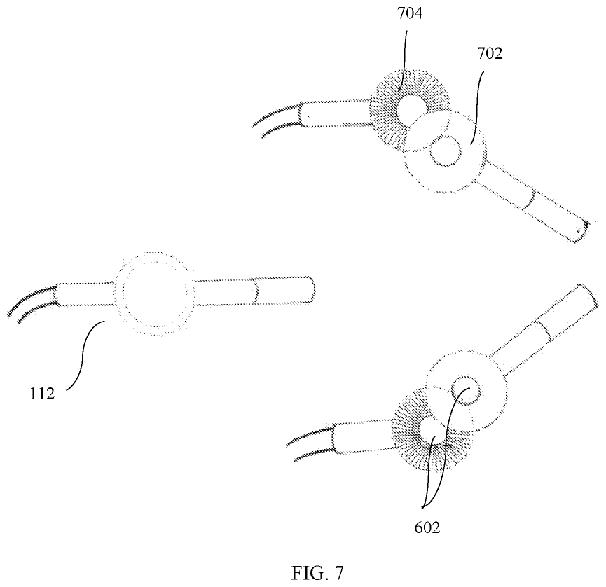

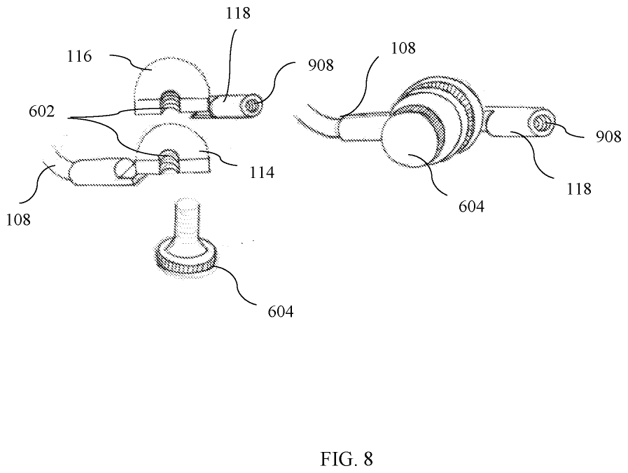

FIG. 6 includes exemplary illustrations of the pair of side hinges 112 of the outer bow 104 in different views according to the embodiments of the present disclosure. FIG. 7 illustrates the working mechanism of the pair of side hinges 112 in the dynamic and static states according to the embodiments of the present disclosure. FIG. 8 includes illustrations of the pair of side hinges 112 according to the embodiments of the present disclosure. The pair of side hinges 112 comprising the first section 114 and second section 116 are detachable, wherein the first section 114 of the side hinge 112 is welded to the anterior region 108 of the outer bow 104 and the second section 116 is welded to the first interconnected unit 118a of the plurality of interconnected units 118.

The first section 114 and the second section 116 of the pair of side hinges 112 comprise a hole 602 with a threaded insert for facilitating the fastening of the first section 114 and the second section 116 of the side hinge 116 with a fastener 604.

The first section 114 and the second section 116 of the pair of side hinges 112 comprise a smooth outer surface 702 and a grooved inner surface 704, wherein upon fastening the first section 114 and the second section 116 of the pair of side hinges 112, the grooved inner surface 704 of the first section 114 and the second section 116 fit into each other to prevent movement.

In a non-limiting example, the components and dimensions of the pair of side hinges 112 in the anterior region 108 of the outer bow 104 is connected with the side hinge 112 through the part which is welded to the parts of the anterior hinge 106 main base, by a metal weld. The base of the side hinge 112 is 15 mm in diameter and 2 mm in thickness, wherein one side (first section 114) of the base of the side hinge 112 has a smooth surface 702 and the other surface is grooved 704, further the base has a drill hole 602 of 5 mm in diameter. It further comprises a screw 604 with a base of 12 mm and a threaded insert part of 4 mm in length and width, making the total screw length as 10 mm. Further, the secondary base is welded to the first interconnected unit 118a of the plurality of the interconnected units 118.

Overall, the base of the pair of side hinges 112 are 15 mm in diameter and thickness of 2 mm and has a drill hole 602 in its center with 5 mm diameter. It has a smooth surface 702 and a grooved surface 704 so that it fits the grooved surface 704 of the piece and then the screw 604 inserts in the center of the base and on the side away from the facebow 100 so that it will hold the bases together and stabilize them without movement once screwed.

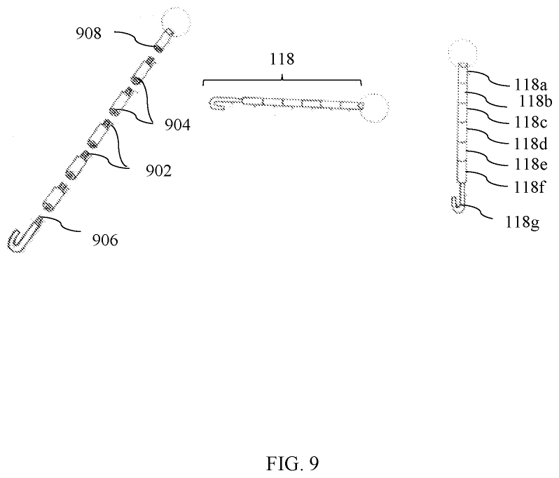

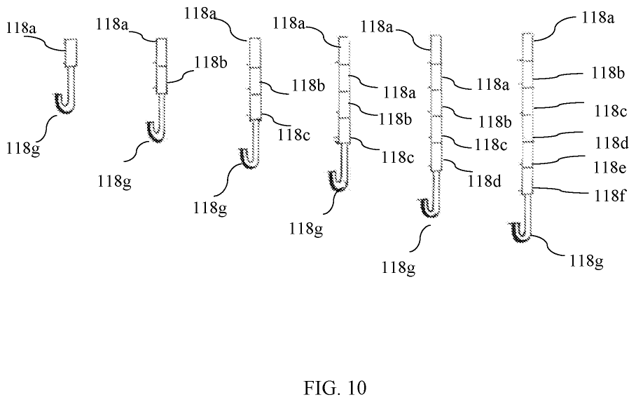

FIG. 9 illustrates different views of the outer-bow 104 arm and its components according to the embodiments of the present disclosure. FIG. 10 illustrates the ability to increase and decrease length of the outer bow 104 arm according to the embodiments of the present disclosure. The plurality of intermediary interconnected units 118b, 118c, 118d, 118e, 118f is cylindrical in shape with a screw 902 positioned centrally to its anterior region and a hole 904 comprising a threaded insert to facilitate insertion of the screw 902. The terminating unit 118g comprises a screw 906 positioned to its centre to facilitate fastening to the first interconnected unit 118a or to at least one of the plurality of the intermediary interconnected units 118b, 118c, 118d, 118e, 118f.

In another non-limited example, the lateral part of the outer bow is 65-72 mm in length from both the ends of the side hinge 112 towards the j-hook unit 118g i.e., from the first interconnected unit 118a followed by the plurality of intermediary unit (118b, 118c, 118d, 118e, 118f) and in the end the terminating unit 118g.

In another non-limiting example, the first interconnected unit 118a is cylindrical in shape welded to the side hinge 112 on one side (particularly to the second section 116), and on the other side has a drill hole 908 diameter of 3 mm (approx.), so that other plurality of intermediary units 118b, 118c, 118d, 118e, 118f or the terminating unit 118g inserts into it. The plurality of intermediary units 118b, 118c, 118d, 118e, 118f are cylindrical in shape with 1.5 cm in length from the head of the screw 902 to its end. Further its anterior end is a 0.5 mm screw 902 at the center of the cylindrical part. Its posterior end is a drill hole 904 of 3 mm diameter and 0.5 cm depth. The j-hook represents the terminating unit 118g of the outer bow 104, wherein it is 1.7 to 2 cm in length with screw 906 part 0.5 cm in length.

The proposed invention comprising the modifiable orthodontic facebow 100 provides the following advantages over the prior art by providing the anterior hinge 106 that connects the interchangeable inner bow 102 (by facilitating insertion and removal) according to the size and measurement of the dento-alveolar arch of the patient and the facebow 100 in general. As a result, the proposed apparatus can be used with multiple patients despite the differences in their conditions.

It may be further appreciated that the main protection elements of the present invention include its side arms of the outer bow 104 of the modifiable orthodontic facebow 100, characterized by its capability to increase and/or decrease in length by the small metallic pieces i.e., the plurality of intermediary interconnected units 118b, 118c, 118d, 118e, 118f, whenever needed and then fixed according to the required length, wherein the length of the varies between 0.5 to 3 cm and the general length of the outer bow 104 arm varies between 1.5 to 10 cm.

Furthermore, importantly the pair of side hinges 122 of the present invention is characterized by its ability to rotate 360 degrees 1 planes of space and then fixed in the required position. Also, the capability of the anterior hinge 106 in connecting the inner bow 102 and the outer bow 104 where it facilitates inner bow 102 insertion/removal and repositioning in three planes of space then fixed in the final needed position.

The modification carried out on the traditional facebow brings in length adjustability without any permanent deforming bends on it. Furthermore importantly, the pair of side hinges 112 on the outer bow 104 arm located at the beginning allows the outer bow 104 arm to be manipulated to a plurality of angles, which would not make it parallel vertically with the inner bow 102 arm when the facebow 100 is placed on a flat surface. The pair of side hinges 112 in the outer bow 104 allows the user to dismantle the outer bow 104 to separate pieces. This is not achievable in the traditional facebow arms without resulting in a deforming bend.

These technical features and capabilities allow the application of asymmetric active force system, easily and in little time. Accordingly, the proposed invention when compared to the prior-arts provide the ability to control the line of action of force, magnitude, position, point of force application and direction (sense) antero-posteriorly and vertically by increasing or decreasing the outer bow 104 length through the small plurality of intermediary interconnected units, and by the pair of side hinges 112 on the outer bow 104 which allows it to be elevated or lowered as required, which will allow symmetric/asymmetric force system according to the malocclusion and its desired method of treatment.

Further in addition to the anterior hinge 106 welded to the mid-section of the outer bow 104 of the face bow 100 and on the other side of the anterior hinge 106 comprises means for insertion of the inner bow 102 after fixing its position in transverse plane, to achieve harmony between the upper dental midline and inner bow midline in case dental midline is deviated to one side. The anterior hinge 106 allows for inner bow 102 replacement when needed, especially when deformed by bends to make it fit to the patients dento-alveolar arch circumference, then it can be fixed and stabilized to the anterior hinge 106.

Contrary to the traditional face-bow, which doesn't allow for modifying outer bow's length and its rotation around 360 degrees, which would limit the ability to control and determine the line of action of force, direction, point of application, and so renders it unable to apply asymmetric force system without causing permanent deformation bends on outer bow 104. Further, the need to purchase different pre-determined facebow sizes in most cases, it's availability, time needed to bring it, cost-effectiveness, and limited use makes the prior art facebows inferior to the present invention. Since the modifiable orthodontic facebow 100 of the present invention allows multi-purpose use (universal), time and cost effective to patient and dentists in general.

It may be noted that the above-described examples of the present solution are for the purpose of illustration only. Although the solution has been described in conjunction with a specific embodiment thereof, numerous modifications may be possible without materially departing from the teachings and advantages of the subject matter described herein. Other substitutions, modifications and changes may be made without departing from the spirit of the present solution. All the features disclosed in this specification (including any accompanying claims, abstract and drawings), and/or all of the steps of any method or process so disclosed, may be combined in any combination, except combinations where at least some of such features and/or steps are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter.

What is claimed is:

1. A modifiable orthodontic facebow, comprising:
an inner bow adapted to be inserted into a buccal tube of a molar band; and
an outer bow connected to the inner bow by means of an anterior hinge, wherein the anterior region of the outer bow is connected to the posterior region of the outer bow 104 through a pair of side hinges comprising a first section and a second section, wherein the posterior region of the outer bow comprises a plurality of interconnected units, wherein a first interconnected unit is fixed to the second section of the side hinge followed by a plurality of intermediary interconnected units with a terminating unit comprising a j-hook to secure an elastic band.

2. The modifiable orthodontic facebow as claimed in claim 1, wherein the anterior hinge of the outer bow facilitates insertion and removal of the inner bow of varying sizes.

3. The modifiable orthodontic facebow as claimed in claim 1, wherein the anterior hinge comprises a posterior drill hole to facilitate non-removable insertion of the mid-section of the outer bow by welding it in place.

4. The modifiable orthodontic facebow as claimed in claim 1, wherein the anterior hinge comprises an inner bow holder section with a removable upper part comprising a semi-circular recess and a fixed lower part comprising a mating semi-circular recess, wherein both the semi-circular recess and the mating semi-circular recess facilitates attachment of the inner bow to the anterior hinge.

5. The modifiable orthodontic facebow as claimed in claim 1, wherein the removable upper part and the fixed lower part of the inner bow holder section are joined together by a fastening mechanism, wherein the fastening mechanism is facilitated by a retention drill hole with a threaded insert for a fastener.

6. The modifiable orthodontic facebow as claimed in claim 1, wherein the pair of side hinges comprising the first section and second section are detachable, wherein the first section of the side hinge is welded to the anterior region of the outer bow and the second section is welded to the first interconnected unit of the plurality of interconnected units of the outer bow.

7. The modifiable orthodontic facebow as claimed in claim 1, wherein the first section and the second section of the pair of side hinges comprises a hole with a threaded insert for facilitating fastening of the first section and the second section of the side hinge with a fastener.

8. The modifiable orthodontic facebow as claimed in claim 1, wherein the first section and the second section of the pair of side hinges comprises a smooth outer surface and a grooved inner surface, wherein upon fastening the first section and the second section of the pair of side hinges, the grooved surface of the first section and the second section fit into each other to prevent movement.

9. The modifiable orthodontic facebow as claimed in claim 1, wherein the plurality of intermediary interconnected units are cylindrical in shape with a screw positioned centrally to its anterior region and a hole comprising a threaded insert to facilitate insertion of the screw, wherein the first interconnected unit comprises of a hole to facilitate attachment at least one of the plurality of the intermediary interconnected units.

10. The modifiable orthodontic facebow as claimed in claim 1, wherein the terminating unit of j-hook comprises a screw positioned to its centre to facilitate fastening to the first interconnected unit or to at least one of the plurality of the intermediary interconnected units.

11. The modifiable orthodontic facebow as claimed in claim 1, wherein the pair of side hinges exhibits a capability to rotate degrees 1 plane of space.
